(19) United States
(12) Patent Application Publication
(10) Pub. No.: US 2008/0165826 A1
(43) Pub. Date: Jul. 10, 2008

(54) TRANSISTOR CIRCUIT CAPABLE OF ELIMINATING INFLUENCE OF COMPONENT PARAMETER AND TEMPERATURE SENSING APPARATUS USING THE SAME

(75) Inventors: Ping-Pao Cheng, Hsinchu County (TW); Yen-Hung Chen, Tainan City (TW)

Correspondence Address: J C PATENTS, INC., 4 VENTURE, SUITE 250, IRVINE, CA, 92618, US

(73) Assignee: ITE TECH. INC., Hsinchu (TW)

(21) Appl. No.: 11/747,831

(22) Filed: May 11, 2007

(30) Foreign Application Priority Data
Jan. 5, 2007 (TW) 96100467

(51) Int. Cl. G01K 7/00; G05F 3/16

(52) U.S. Cl. 374/178; 323/315

(57) ABSTRACT

A transistor circuit capable of eliminating influence of component parameter and a temperature sensing apparatus using the same are disclosed in the invention. The temperature sensing apparatus includes a current-producing unit, a switching unit, a current-duplicating unit and a transistor. The temperature sensing apparatus is used to measure ambient temperature utilizing the voltage difference of the base and the emitter of the transistor varied with temperature. The current-duplicating unit duplicates the base current of the transistor and applies the duplicated current to the emitter of the transistor so as to avoid the influence of a component parameter variation of the transistor at different temperatures and to eliminate the measurement error caused by a component parameter difference between different transistors. Therefore, the novel temperature sensing apparatus improves the precision and the accuracy of temperature measurement.

### CROSS-REFERENCE TO RELATED APPLICATION

This application claims the priority benefit of Taiwan application serial no. 96100467, filed Jan. 5, 2007. All disclosure of the Taiwan application is incorporated herein by reference.

### BACKGROUND OF THE INVENTION

1. Field of the Invention

The present invention generally relates to a temperature sensing apparatus utilizing transistor characteristic, and more particularly, to a temperature sensing apparatus capable of eliminating the influence of component parameter.

2. Description of Related Art

Due to a bipolar transistor (BJT) with two pn junctions and the material behavior thereof, the voltage difference between the base and the emitter of the BJT would be altered accompany temperature as the BJT is situated in a forward bias, and the relationship between base-emitter voltage and temperature is expressed by the following equation:

V_{BE}=kT/q*ln(I_{C}/I_{S}) (1)

where V_{BE} is the voltage difference between the base and the emitter of the BJT in unit of volt [V], k is the Boltzman's constant, T is thermodynamic temperature of environment in unit of Kelvin [K], q is the electron charge in unit of coulomb [C], I_{C} is collector current in unit of ampere [A] and I_{S} is saturation current [A].

In the prior art, there is a temperature sensing apparatus based on the BJT characteristic of the base-emitter voltage thereof varying with temperature. FIGS. 1a and 1b are schematic circuit diagram of two kinds of conventional temperature sensing apparatuses. Referring to FIG. 1a, the temperature sensing apparatus employs two current sources 113 and 116 to produce two stable currents I₁ and I₂, and then two employed switches S₁ and S₂ alternately output the currents I₁ and I₂ to a transistor 130, so as to make the transistor 130 to produce a voltage differences V_{BE1} and V_{BE2} between the base and the emitter. After that, a measurement unit (not shown) is used to measure the voltages V_{BE1} and V_{BE2} and an environment temperature can be obtained by calculating the measured voltages. The circuit operation of FIG. 1a is described in detail as follows.

When the switch S₁ is turned on and the switch S₂ is turned off, the current I₁ is input to the emitter of the transistor 130, which drives the transistor 130 to produce a collector current I_{C1} and a voltage difference V_{BE1} of the base and the emitter. By using the above-mentioned equation (1), the following equation (2) can be derived:

V_{BE1}=kT/q*ln(I_{C1}/I_{S}) (2)

Since the current gain, β_{I} of a transistor is given, the collector current I_{C1} herein can be calculated by

$${I}_{C 1} = \frac{{I}_{E 1}}{1 + 1 / {β}_{1}} .$$

The emitter current I_{E1} herein is the current I₁ output from the current source 113, thus the above-mentioned equation (2) can be rewritten as follows:

$${V}_{BE 1} = kT / q * ln [ ( \frac{{I}_{1}}{1 + 1 / {β}_{1}} ) / {I}_{s} ] \qquad ( 3 )$$

where β₁ represents the current gain of the transistor at the time.

On the contrary, when the switch S₂ is closed and the switch S₁ is open, the current I₂ would be input to the emitter of the transistor 130 to drive the transistor 130 to produce a collector current I_{C2} and a voltage difference V_{BE2} of the base and the emitter. Similarly, by using the above-mentioned equation (1) and the current gain of the transistor, we have:

$${V}_{BE 2} = kT / q * ln [ ( \frac{{I}_{2}}{1 + 1 / {β}_{2}} ) / {I}_{s} ] \qquad ( 4 )$$

where β₂ represents the current gain of the transistor at the time.

Then, V_{BE1} and V_{BE2} are respectively measured, followed by calculating the difference value ΔV_{BE} between V_{BE1} and V_{BE2}. According to the above-mentioned equations (3) and (4), the following equation of ΔV_{BE} can be represented as:

$$Δ {V}_{BE} = {V}_{BE 1} - {V}_{BE 2} = kT / q * ( \frac{{I}_{1}}{{I}_{2}} ) * ( \frac{1 + 1 / {β}_{2}}{1 + 1 / {β}_{1}} ) \qquad ( 5 )$$

In the prior art, the differential value ΔV_{BE} between V_{BE1} and V_{BE2} is calculated by omitting the difference between β₁ and β₂, that is to say assuming the two current gains are equal to each other, β₁=β₂. Therefore, the above-mentioned equation (5) can be rewritten as follows:

$$Δ {V}_{BE} = {V}_{BE 1} - {V}_{BE 2} = kT / q * ( \frac{{I}_{1}}{{I}_{2}} ) \qquad ( 6 )$$

wherein since k and q are constants, and I₁ and I₂ are respectively a known input current, the difference value ΔV_{BE} is related to environment temperature T only. In other words, the environment temperature T can be obtained by measuring the difference value ΔVBE.

There is another conventional temperature sensing apparatus, as shown by FIG. 1b. Referring to FIG. 1b, the operation of FIG. 1b is similar to that of FIG. 1a, except for, the currents I₁ and I₂ in FIG. 1b are respectively input to two different transistors 132 and 134 for producing voltage differences V_{BE1} and V_{BE2} between the base and the emitter, respectively. Thus, by respectively measuring voltage differences V_{BE1} and V_{BE2} of the transistors 132 and 134, the differential value ΔV_{BE} of t V_{BE1} and V_{BE2}, and hereby the environment temperature T, can be obtained.

Here if β₁ in the above-mentioned equation (3) is used to refer the current gain of the transistor 132, the voltage difference V_{BE1} in FIG. 1b can be calculated by means of the above-mentioned equation (3). Similarly, If β₂ in the above-mentioned equation (4) is used to refer the current gain of the transistor 134, the voltage difference V_{BE2} in FIG. 1b can be calculated by means of the above-mentioned equation (4). In the same way as the above-mentioned equation (6) where the difference between the current gain β₁ of the transistor 132 and the current gain β₂ of the transistor 134 can be omitted, the ambient temperature T can be obtained by calculating the differential value ΔV_{BE} of t V_{BE1} and V_{BE2}.

It is an approximation assumption that two current gains β₁ and β₂ are equal to one another. In fact however, in terms of a transistor, the current gain thereof would slightly vary with an ambient temperature change, which makes the transistor 130 in FIG. 1a fail to retain a same current gain when measuring the the voltage difference of the base and the emitter V_{BE1} and V_{BE2}. On the other hand, depending on behaviour of a semiconductor process, the current gain β₁ of the transistor 132 in FIG. 1b is not equal to the current gain β₁ of the transistor 134 as well. It can be seen that with a conventional temperature sensing apparatus, the regardless differences between two current gains, occurred in a differential temperature or a differential process, would cause a measurement error when measuring temperature in practice and make the precision and the accuracy of the measurement to lower.

### SUMMARY OF THE INVENTION

Accordingly, the present invention is directed to a transistor circuit capable of eliminating the influence of component parameter, wherein the influence of component parameter is eliminated by duplicating the base current of a transistor to the emitter of the transistor.

The present invention is also directed to a temperature sensing apparatus capable of avoiding the influence of component parameter to accurately measure an environment temperature.

As embodied and broadly described herein, the present invention provides a transistor circuit capable of eliminating the influence of component parameter. The transistor circuit includes a current-producing unit, a first transistor, a switching unit and a current-duplicating unit. The current-producing unit in the transistor circuit produces a first current and a second current; the switching unit determines whether the first current or the second current is output to the emitter of the first transistor; and the current-duplicating unit duplicates the base current of the first transistor according to a proportion and applies the duplicated current to the emitter of the first transistor.

The present invention provides a temperature sensing apparatus, including a current-producing unit, a first transistor, a switching unit, a current-duplicating unit and a measurement unit. The current-producing unit in the temperature sensing apparatus produces a first current and a second current; the switching unit determines whether the first current or the second current is output to the emitter of the first transistor; and the current-duplicating unit duplicates the base current of the first transistor according to a proportion and applies the duplicated current to the emitter of the first transistor. The measurement unit measures the voltage difference between the base and the emitter of the first transistor as the first current flows through the emitter of the first transistor and as the second current flows through the emitter of the first transistor as well, and further calculates an ambient temperature by using the measured base-emitter voltages.

The present invention provides a transistor circuit capable of eliminating the influence of component parameter. The transistor circuit includes a current-producing unit, a first transistor, a second transistor and a current-duplicating unit. The current-producing unit in the transistor circuit produces a first current and a second current, which are respectively input to the first transistor and the second transistor. The current-duplicating unit duplicates the base current of the first transistor according to a first proportion and applies the duplicated current to the emitter of the first transistor, and duplicates the base current of the second transistor according to a second proportion and applies the duplicated current to the emitter of the second transistor.

The present invention provides a temperature sensing apparatus, which includes a current-producing unit, a first transistor, a second transistor, a current-duplicating unit and a measurement unit. The current-producing unit in the temperature sensing apparatus produces a first current and a second current, which are respectively input to the first transistor and the second transistor. The current-duplicating unit duplicates the base current of the first transistor according to a first proportion and applies the duplicated current to the emitter of the first transistor, and duplicates the base current of the second transistor according to a second proportion and applies the duplicated current to the emitter of the second transistor. The measurement unit measures the voltage difference between the base and the emitter of the first transistor and the voltage difference between the base and the emitter of the second transistor, and further calculates an environment temperature by using the measured the voltage difference between the base and the emitter.

Since the present invention employs a current-duplicating unit in the temperature sensing apparatus to duplicate the base current of the transistor therein and to apply the duplicated current to the emitter of the transistor, therefore, the present invention is capable of solving the measurement error caused by the component parameter differences regardless of a same transistor but under different temperatures or with different transistors. In this way, the precision and the accuracy of temperature measurement are significantly advanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1a and 1b are schematic circuit diagram of two kinds of conventional temperature sensing apparatuses.

FIG. 2a is a circuit block diagram of a temperature sensing apparatus according to an embodiment of the present invention.

FIG. 2b is a schematic diagram of a transistor circuit according to an embodiment of the present invention.

FIG. 3 is a schematic circuit diagram of another transistor circuit according to an embodiment of the present invention.

FIG. 4 is a schematic diagram of yet another transistor circuit according to an embodiment of the present invention.

FIG. 5a is a circuit block diagram of another temperature sensing apparatus according to an embodiment of the present invention.

FIG. 5b is a schematic diagram of yet another transistor circuit according to an embodiment of the present invention.

FIG. 6 is a schematic circuit diagram of yet another transistor circuit according to an embodiment of the present invention.

FIG. 7 is a schematic circuit diagram of yet another transistor circuit according to an embodiment of the present invention.

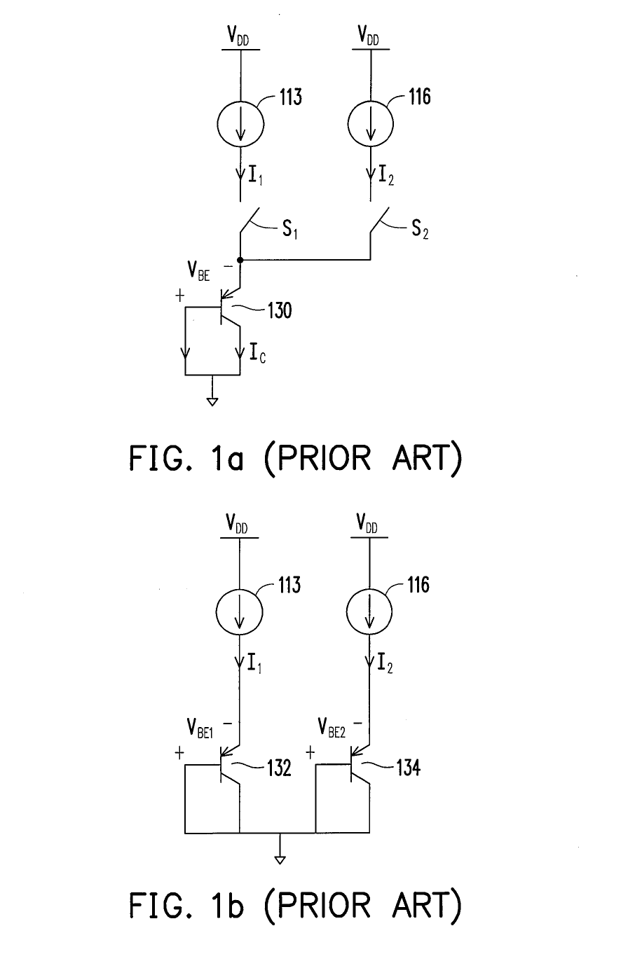

### DESCRIPTION OF THE EMBODIMENTS

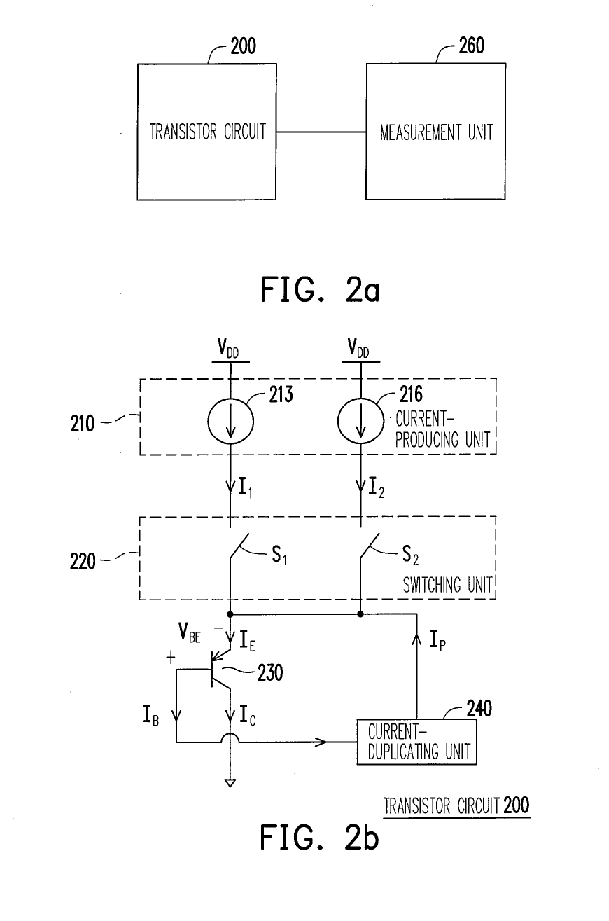

FIG. 2a is a circuit block diagram of a temperature sensing apparatus according to an embodiment of the present invention. Referring to FIG. 2a, the temperature sensing apparatus includes a transistor circuit 200 and a measurement unit 260. The schematic diagram of the transistor circuit 200 according to the embodiment of the present invention is shown by FIG. 2b in detail. Referring to FIG. 2b, the transistor circuit 200 includes a current-producing unit 210, a switching unit 220, a first transistor 230 and a current-duplicating unit 240. The current-producing unit 210 includes two current sources 213 and 216. The switching unit 220 in FIG. 2 includes two switches S₁ and S₂. The operation of the temperature sensing apparatus is explained FIGS. 2a and 2b as follows.

First, the current sources 213 and 216 respectively produce a fixed first current I1 and a fixed second current I₂, the produced currents are input to the switching unit 220, and the switches S₁ and S₂ in the switching unit 220 alternately switch the first current I₁ and the second current I₂ to the emitter of the first transistor 230. Meanwhile, the current-duplicating unit 240 duplicates the base current I_{B} of the transistor 230 according to a proportion and the duplicated current is used as a compensation current I_{P} to be output to the emitter of the transistor 230.

When the switch S₁ is turned on and the switch S₂ is turn off the current I₁ is input to the emitter of the transistor 230, then the compensation current I_{P} output from the current-duplicating unit 240 is input to the emitter of the transistor 230 as well, so that the transistor 230 is driven to produce a collector current, a base current and a voltage difference between the base and the emitter. Here, for clearly explaining the embodiment, while the current I₁ is input to the emitter of the transistor 230, the collector current of the transistor 230 is represented as I_{C1}, the base current is represented as I_{B1}, and the voltage difference between the base and the emitter is represented V_{BE1}. So the input currents and the output currents of the transistor 230 are subjected to the following relationship:

I₁+I_{P}=I_{C1}+I_{B1} (7)

In the present embodiment, if the proportion of the compensation current I_{P} duplicated by the current-duplicating unit 240 over the base current I_{B1} of the transistor 230 is defined as 1:1 by design, the output current I₁ of the current sources 213 would be equal to the collector current I_{C1} of the transistor 230 just by deriving from the above-mentioned equation (7).

At the time, the measurement unit 260 measures the voltage difference V_{BE1} of the transistor 230. At the time, the voltage difference V_{BE1} of the transistor 230 is given by the above-mentioned equation (1):

V_{BE1}=kT/q*ln(I_{C1}/I_{S}) (8)

In consideration of I_{C1}=I₁, thus

V_{BE1}=kT/q*ln(I₁/I_{S}) (9)

where k and q are constants and I₁ is the fixed current produced by the current source 213, therefore, the voltage difference V_{BE1} of the transistor 230 at the time is related to the ambient temperature only.

Next, when the switch S₂ is turned on and the switch S₁ is turned off, the current I₂ is input to the emitter of the transistor 230, then the compensation current I_{P} output from the current-duplicating unit 240 is input to the emitter of the transistor 230 as well, so that the transistor 230 is driven to produce a collector current, a base current and a voltage difference between the base and the emitter. Here, for clearly explaining the embodiment, while the current I₂ is input to the emitter of the transistor 230, the collector current of the transistor 230 is represented as I_{C2}, the base current is represented as I_{B2}, and the voltage difference between the base and the emitter is represented V_{BE2}. Similar to the equation (7), it can be derived that the output current I₂ of the current sources 213 equal to the collector current I_{C2} of the transistor 230.

At the time, the measurement unit 260 also measures the voltage difference V_{BE2} of the transistor 230. Similar to the equation (8), the voltage difference V_{BE2} of the transistor 230 at the time can be derived from the relationship between the input currents and the collector current I_{C2} of the transistor 230 and the above-mentioned equation (1):

$$\begin{matrix}{V}_{BE 1} = kT / q * ln ( {I}_{C 2} / {I}_{S} ) \\ = kT / q * ln ( {I}_{2} / {I}_{S} )\end{matrix} \qquad ( 10 )$$

Finally, the measurement unit 260 calculates the difference ΔV_{BE} between V_{BE1} and V_{BE2} by using the above-mentioned equations (9) and (10):

$$\begin{matrix}Δ {V}_{BE} = {V}_{BE 1} - {V}_{BE 2} \\ = kT / q * ln ( \frac{{I}_{1}}{{I}_{2}} ) \\ = kT / q * ln ( n )\end{matrix} \qquad ( 11 )$$

where n represents the proportion of the current I₁ over the current 12. Considering k and q are constants and n is a given ratio of the currents I₁ and I₂, therefore the difference value ΔV_{BE} is related to the ambient temperature T only. That is to say, the environment temperature T can be obtained through the voltage difference V_{BE1} and V_{BE2} measured by the measurement unit 260.

It can be seen from the above-mentioned embodiment, compared to the conventional temperature sensing apparatus, in the apparatus of the present embodiment, a compensation current output from the current-duplicating unit 240 is used to stabilize the collector current of the transistor 230. Thus, the temperature sensing apparatus of the present invention is able to solve the problem of the prior art that the current gains β₁ and β₂ are not equal to each other when measuring the voltage difference V_{BE1} and V_{BE2} of the transistor 230. In other words, the temperature sensing apparatus of the present invention can entirely avoid the effect of imperfect transistor component parameter and promote the precision and the accuracy of temperature measurement.

It should be noted although the present embodiment has provided a feasible implementation type of a temperature sensing apparatus, whereas it is well known to anyone skilled in the art that each manufacturer has different design for a temperature sensing apparatus. Therefore, the present invention should not be limited to the above-mentioned implementation. In other words, once a temperature sensing apparatus adopts such a scheme that duplicating the base current of a transistor therein and inputting the duplicated current to the emitter of the transistor to stabilize the collector current of the transistor and hereby to eliminate the influence of component parameter, the temperature sensing apparatus is considered to be within the scope of the present invention.

In order for anyone skilled in the art to implement the present invention, the following embodiments are further described.

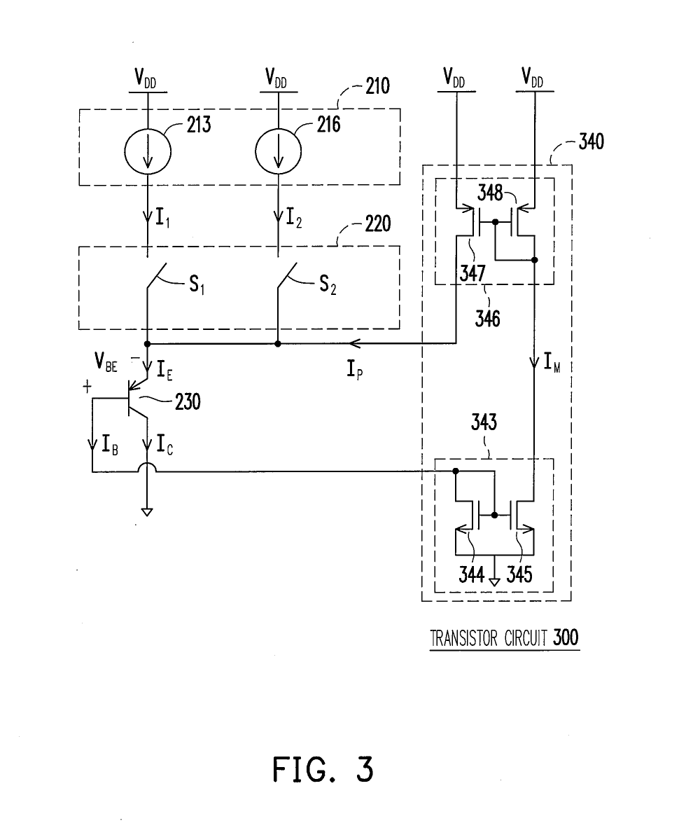

FIG. 3 is a schematic circuit diagram of another transistor circuit according to the embodiment of the present invention. Referring to FIG. 3, a transistor circuit 300 includes a current-producing unit 210, a switching unit 220, a first transistor 230 and a current-duplicating unit 340. The current-producing unit 210, the switching unit 220 and the first transistor 230 herein have the same as FIG. 2b, thus, description thereof are omitted. The current-duplicating unit 340 in the present embodiment is implemented by employing a first current mirror 343 and a second current mirror 346.

Both the current mirrors 343 and 346 respectively have a primary side and a slave side, wherein the primary side of the transistor 343 receives the base current I_{B} of the transistor 230 and the slave side thereof produces a mirror current I_{M}. After the primary side of the transistor 346 receives the mirror current I_{M}, the slave side of the transistor 346 produces a compensation current I_{P} to be input to the emitter of the transistor 230.

In the present embodiment, the current mirror 343 is implemented, for example, by employing two NMOS transistors 344 and 345, wherein two gates thereof are electrically connected to each other; the current mirror 346 is implemented, for example, by employing two PMOS transistors 347 and 348, wherein two gates thereof are electrically connected to each other. The proportion of the base current I_{B} over the compensation current I_{P} of the transistor 230 can be adjusted through the transistor component size (for example, of width-to-length ratio of the channel). For example, in order to make the proportion of the base current I_{B} over the compensation current I_{P} be 1:1, the width-to-length ratio of the transistors 344 and 345 can be, for example, 1:A, and the relationship between the mirror current I_{M} and the base current I_{B} is I_{M}=AI_{B}. On the other hand, by specifying the width-to-length ratio of the transistors 348 and 347 are, for example, A:1, thus, the relationship between the compensation current I_{P} and the mirror current I_{M} is I_{P}=(1/A)I_{M}. Consequently, by specifying the above-mentioned channel aspects, the base current I_{B} of the transistor is equal to the compensation current I_{P}.

However, anyone skilled in the art would know that the current mirrors 343 and 346 can also be implemented by using BJTs in addition to MOS transistors. Furthermore, the current mirrors 343 and 346 in the present embodiment can be other types of current mirror, such as a cascade current mirror or an active current mirror in addition to the basic current mirror adopted by the above-mentioned embodiment.

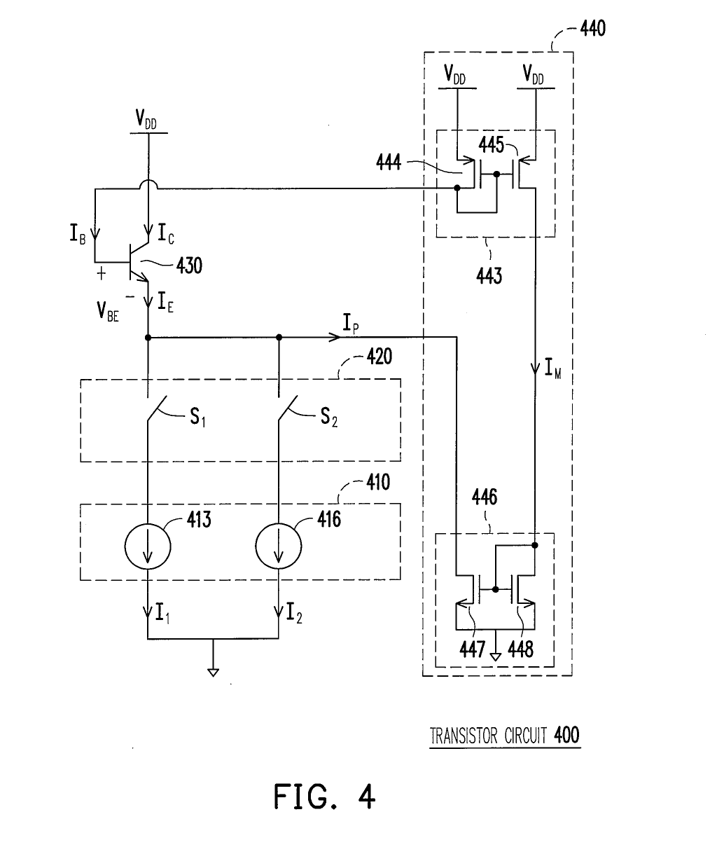

FIG. 4 is a schematic circuit diagram of yet another transistor circuit according to the embodiment of the present invention. Referring to FIG. 4, a transistor circuit 400 includes a current-producing unit 410, a switching unit 420, a first transistor 430 and a current-duplicating unit 440. The operation of the present embodiment is similar to the embodiment in FIG. 3 except for the transistor 430 herein is implemented by an NPN-type BJT. Thus, if the transistor circuit 400 is used in the temperature sensing apparatus 260 of FIG. 2a, the apparatus 260 is able to measure the voltage differences V_{BE1} and V_{BE2} between the base and the emitter of the transistor 430 and hereby obtain an ambient temperature T.

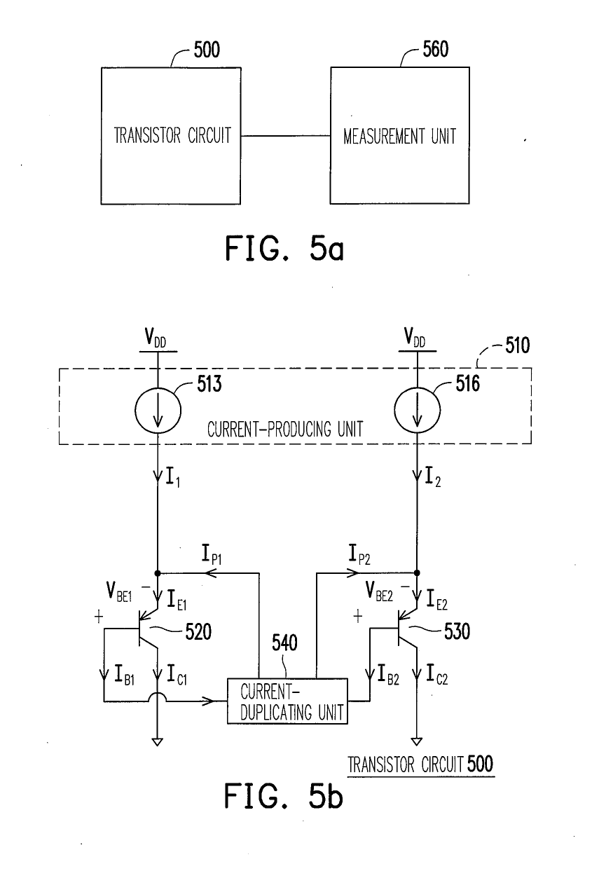

FIG. 5a is a circuit block diagram of another temperature sensing apparatus according to an embodiment of the present invention. Referring to FIG. 5a, the temperature sensing apparatus includes a transistor circuit 500 and a measurement unit 560. The schematic diagram of the transistor circuit 500 is shown by FIG. 5b. Referring to FIG. 5b, the transistor circuit 500 includes a current-producing unit 510, a first transistor 520, a second transistor 530 and a current-duplicating unit 540. The current-producing unit 510 includes two current sources 513 and 516.

The operation of the present embodiment in FIG. 5b is similar to the embodiment in FIG. 2b except that the embodiment of FIG. 5b does not employ a switching unit. Instead, the present embodiment two transistors 520 and 530 are simultaneously used to receive a first current I₁ and a second current I₂ respectively and produce the voltage differences (V_{BE1} and V_{BE2} ) between the base and the emitter of the transistors 520 and 530. In the same way, the voltage differences V_{BE1} and V_{BE2} are measured by the measurement unit 560 in the FIG. 5a to obtain a ambient temperature.

In the embodiment, a first current I₁ and a second current I₂ respectively produced by the current sources 513 and 516 are input to the transistors 520 and 530, respectively. The current-duplicating unit 540 duplicates the base current I_{B1} of the transistor 520 according to a first proportion, and the duplicated current is used as a first compensation current I_{P1} to be output to the emitter of the transistor 520. On the other hand, the current-duplicating unit 540 also duplicates the base current I_{B2} of the transistor 530 according to a second proportion, and the duplicated current is used as a second compensation current I_{P2} to be output to the emitter of the transistor 530.

If the first compensation current I_{P1} output from the current-duplicating unit 540 is equal to the base current I_{B1} of the transistor 520 and the second compensation current I_{P2} is equal to the base current I_{B2} of the transistor, the voltage difference V_{BE1} between the base and the emitter of the transistor 520 would be expressed by the same equation as the above-mentioned equation (9) and the the voltage difference V_{BE2} between the base and the emitter of the transistor 530 would be expressed by the same equation as the above-mentioned equation (10).

After that, the measurement unit 560 respectively measures the voltage difference V_{BE1} of the transistor 520 and the voltage difference V_{BE2} of the transistor 530, followed by taking the difference value ΔV_{BE} to obtain the ambient temperature T, wherein the difference value ΔV_{BE} is calculated by using the same equation as the above-mentioned equation (11).

It can be seen from the above-mentioned embodiment, compared to the conventional temperature sensing apparatus, the apparatus of the present invention employs a current-duplicating unit 540 to output two compensation currents so as to respectively stabilize the base currents of two transistors 520 and 530. Thus, the temperature sensing apparatus of the present invention is able to solve the problem of the prior art that the current gains β₁ and β₂ are not equal to each other when measuring the voltage difference V_{BE1} of the transistor 520 and the voltage difference V_{BE2} of the transistor 530. In other words, the temperature sensing apparatus of the present invention can entirely avoid the effect of imperfect transistor component parameter and promote the precision and the accuracy of temperature measurement.

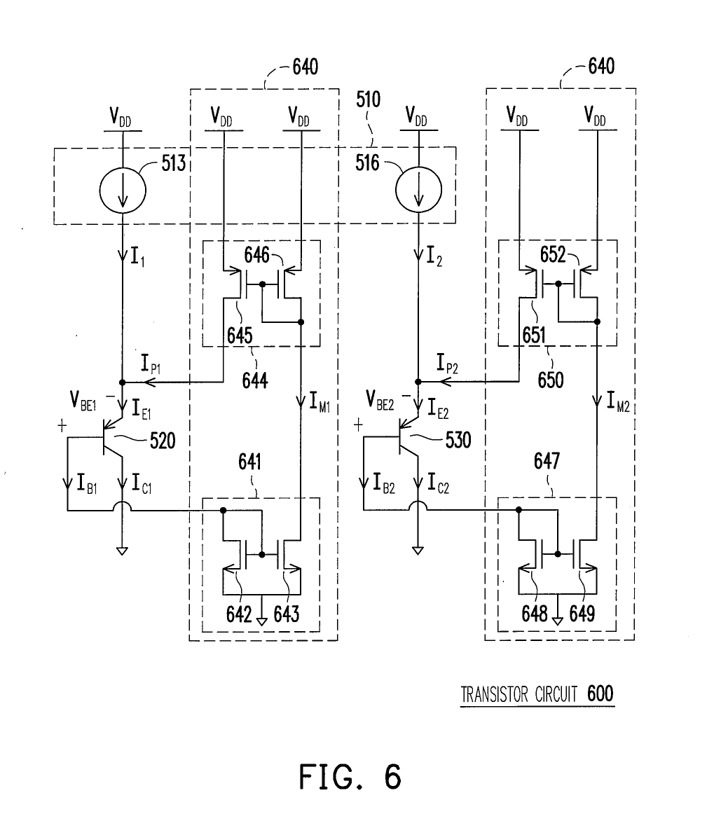

FIG. 6 is a schematic circuit diagram of yet another transistor circuit according to an embodiment of the present invention. Referring to FIG. 6, a transistor circuit 600 includes a current-producing unit 510, a first transistor 520, a second transistor 530 and a current-duplicating unit 640. The current-producing unit 510, the first transistor 520 and the second transistor 530 are the same as the above-mentioned embodiment of FIG. 5b, and therefore description thereof are omitted. The current-duplicating unit 640 in the embodiment is implemented by using a first current mirror 641, a second current mirror 644, a third current mirror 647 and a fourth current mirror 650.

The current mirrors 641 and 644 have the same operation as that of the current mirrors 343 and 346 in FIG. 3, receive the base current I_{B1} of the transistor 520 and output a first compensation current I_{P1} to the emitter of the transistor 520 to stabilize the collector current of the transistor 520. In the same way, the current mirrors 647 and 650 have the same operation as that of the current mirrors 343 and 346 in FIG. 3, receive the base current I_{B2} of the transistor 530 and output a second compensation current I_{P2} to the emitter of the transistor 530 to stabilize the collector current of the transistor 530.

Anyone skilled in the art would understand that the current mirrors 641, 644, 647 and 650 can also be implemented by using BJTs in addition to MOS transistors. Furthermore, the current mirrors 641, 644, 647 and 650 in the present embodiment can be other types of current mirror, such as a cascade current mirror or an active current mirror in addition to the basic current mirror adopted by the above-mentioned embodiment.

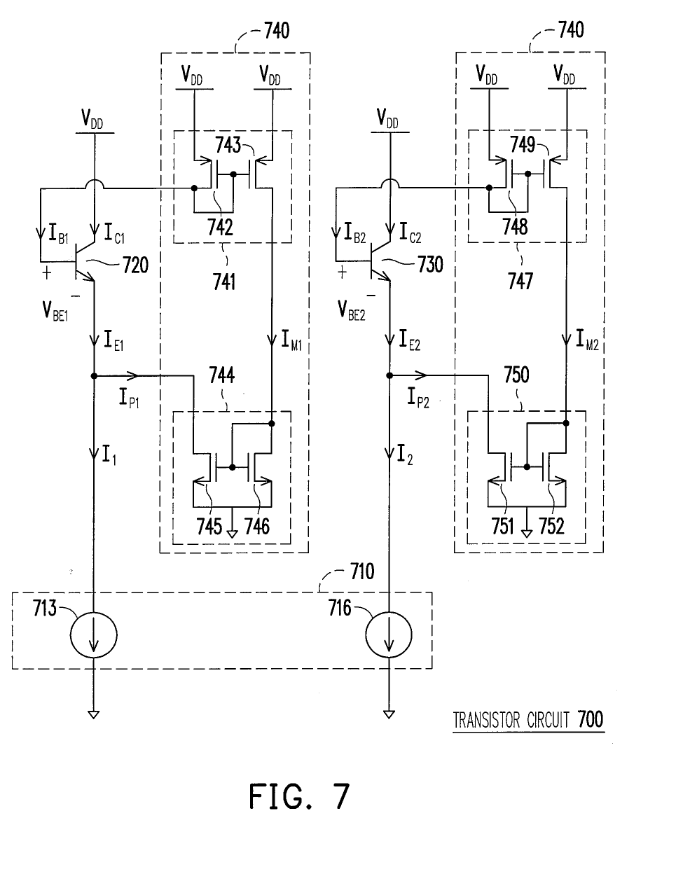

FIG. 7 is a schematic circuit diagram of yet another transistor circuit according to the embodiment of the present invention. Referring to FIG. 7, a transistor circuit 700 includes a current-producing unit 710, a first transistor 720, a second transistor 730 and a current-duplicating unit 740. The operation of the embodiment is the same as the above-mentioned embodiment of FIG. 6 except for the transistors 720 and 730 are implemented by NPN-type BJTs. Thus, if the transistor circuit 700 is used in the temperature sensing apparatus 560 of FIG. 5a, the apparatus 560 is able to measure the voltage differences V_{BE1} and V_{BE2} of the transistors 720 and 730 and obtain an ambient temperature T.

In the above-mentioned embodiments, the proportion of base current over compensation current of the transistor in a current-duplicating unit is assumed to be 1:1 and the base current of the transistor is duplicated to the emitter thereof according to the proportion of 1:1. However, anyone skilled in the art would understand that the base current can not be entirely the same as the compensation current due to a process error during fabricating a MOS transistor. In addition, in terms of a BJT transistor, the base current can not be entirely the same as the compensation current either since it is hard to prevent a small amount of emitter current of a BJT transistor to drain out from the base thereof. Despite all that however, once a temperature sensing apparatus adopts such a scheme that duplicating the base current of a transistor therein and inputting the duplicated current to the emitter of the transistor for compensation purpose, the influence of component parameter may be eliminated.

In summary, the present invention has the following advantages:

1. With a temperature sensing apparatus using a single transistor, the present invention is able to compensate the base current of the transistor by duplicating the base current thereof and applying the duplicated current to the emitter thereof.

2. With a temperature sensing apparatus using two transistors, the present invention is able to simultaneously compensate the base currents of the two transistors by duplicating the base currents of the two transistors and applying the duplicated currents to the emitters thereof.

3. The present invention is able to avoid the consequence on a temperature measurement of a component parameter variation caused by different temperatures during measurement and the present invention is also able to avoid a measurement error caused by a component parameter difference between the two transistors, so that the present invention can promote the precision and the accuracy of temperature measurement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transistor circuit capable of eliminating influence of component parameter, comprising:
a current-producing unit, for producing a first current and a second current;
a first transistor;
a switching unit, for receiving the first current and the second current to determine an emitter of the first transistor to receive the first current or the second current; and
a current-duplicating unit, for duplicating a base current of the first transistor according to a proportion and applying to the emitter of the first transistor.

2. The transistor circuit capable of eliminating influence of component parameter according to claim 1, wherein the current-duplicating unit comprises:
a first current mirror, having a primary side and a slave side, wherein the primary side receives the base current of the first transistor and the slave side produces a mirror current; and
a second current mirror, having a primary side and a slave side, wherein the primary side receives the mirror current and the slave side outputs a compensation current to the emitter of the first transistor.

3. The transistor circuit capable of eliminating influence of component parameter according to claim 2, wherein the first current mirror comprises:
a second transistor, having a first drain/source and a gate coupled to each other and coupled to the base of the first transistor, and a second drain/source thereof coupled to a first reference voltage level; and
a third transistor, having a gate coupled to the gate of the second transistor, wherein a first drain/source thereof outputs the mirror current and the second drain/source thereof is coupled to the first reference voltage level.

4. The transistor circuit capable of eliminating influence of component parameter according to claim 3, wherein the second current mirror comprises:
a fourth transistor, having a first drain/source and a gate coupled to each other and coupled to the first drain/source of the third transistor, and a second drain/source thereof coupled to a second reference voltage level; and
a fifth transistor, having a gate coupled to the gate of the fourth transistor, wherein a first drain/source thereof outputs the compensation current to the emitter of the first transistor and a second drain/source thereof is coupled to the second reference voltage level.

5. The transistor circuit capable of eliminating influence of component parameter according to claim 1, wherein the component parameter comprises current gain of a transistor.

6. A temperature sensing apparatus, comprising:
a current-producing unit, for producing a first current and a second current;
a first transistor;
a switching unit, for receiving the first current and the second current to determine an emitter of the first transistor to receive the first current or the second current;
a current-duplicating unit, for duplicating a base current of the first transistor according to a proportion and applying to the emitter of the first transistor; and
a measurement unit, for measuring the voltage difference of the base and the of the first transistor as the first current flows through the emitter of the first transistor and taking the measured voltage as a first voltage, for measuring the voltage differences of the base and the emitter of the first transistor as the second current flows through the emitter of the first transistor, and taking the measured voltage as a second voltage and for calculating an ambient temperature by using the first voltage and the second voltage.

7. The temperature sensing apparatus according to claim 6, wherein the current-duplicating unit comprises:
a first current mirror, having a primary side and a slave side, wherein the primary side receives the base current of the first transistor and the slave side produces a mirror current; and
a second current mirror, having a primary side and a slave side, wherein the primary side receives the mirror current and the slave side outputs a compensation current to the emitter of the first transistor.

8. The temperature sensing apparatus according to claim 7, wherein the first current mirror comprises:
a second transistor, having a first drain/source and a gate coupled to each other and coupled to a base of the first transistor, while the second drain/source thereof is coupled to a first reference voltage level; and
a third transistor, having a gate coupled to the gate of the second transistor, wherein a first drain/source thereof outputs the mirror current and the second drain/source thereof is coupled to the first reference voltage level.

9. The temperature sensing apparatus according to claim 8, wherein the second current mirror comprises:
a fourth transistor, having a first drain/source and a gate coupled to each other and coupled to the first drain/source of the third transistor, and a second drain/source thereof coupled to a second reference voltage level; and
a fifth transistor, having a gate coupled to the gate of the fourth transistor, wherein a first drain/source thereof outputs the compensation current to the emitter of the first transistor and a second drain/source thereof is coupled to the second reference voltage level.

10. A transistor circuit, capable of eliminating influence of component parameter, comprising:
a current-producing unit, for producing a first current and a second current;
a first transistor, for receiving the first current;
a second transistor, for receiving the second current; and
a current-duplicating unit, for duplicating a base current of the first transistor according to a first proportion and applying to an emitter of the first transistor and for duplicating a base current of the second transistor according to a second proportion and applying to the emitter of the second transistor.

11. The transistor circuit capable of eliminating influence of component parameter according to claim 10, wherein the current-duplicating unit comprises:
a first current mirror, having a primary side and a slave side, wherein the primary side receives the base current of the first transistor and the slave side produces a first mirror current;
a second current mirror, having a primary side and a slave side, wherein the primary side receives the first mirror current and the slave side outputs a first compensation current to the emitter of the first transistor;
a third current mirror, having a primary side and a slave side, wherein the primary side receives the base current of the second transistor and the slave side produces a second mirror current; and
a fourth current mirror, having a primary side and a slave side, wherein the primary side receives the second mirror current and the slave side outputs a second compensation current to the emitter of the second transistor.

12. The transistor circuit capable of eliminating influence of component parameter according to claim 11, wherein the first current mirror comprises:
a third transistor, having a first drain/source and a gate coupled to each other and coupled to the base of the first transistor, and a second drain/source thereof coupled to a first reference voltage level; and
a fourth transistor, having a gate coupled to the gate of the third transistor, wherein a first drain/source thereof outputs the first mirror current and a second drain/source thereof is coupled to the first reference voltage level.

13. The transistor circuit capable of eliminating influence of component parameter according to claim 12, wherein the second current mirror comprises:
a fifth transistor, having a first drain/source and a gate coupled to each other and coupled to the first drain/source of the fourth transistor, and a second drain/source thereof coupled to a second reference voltage level; and
a sixth transistor, having a gate coupled to the gate of the fifth transistor, wherein a first drain/source thereof outputs the first compensation current to the emitter of the first transistor and a second drain/source thereof is coupled to the second reference voltage level.

14. The transistor circuit capable of eliminating influence of component parameter according to claim 13, wherein the third current mirror comprises:
a seventh transistor, having a first drain/source and a gate coupled to each other and coupled to the base of the second transistor, and a second drain/source thereof coupled to the first reference voltage level; and
an eighth transistor, having a gate coupled to the gate of the seventh transistor, wherein a first drain/source thereof outputs the second mirror current and a second drain/source thereof is coupled to the first reference voltage level.

15. The transistor circuit capable of eliminating influence of component parameter according to claim 14, wherein the fourth current mirror comprises:
a ninth transistor, having a first drain/source and a gate coupled to each other and coupled to the first drain/source of the eighth transistor, and a second drain/source thereof coupled to the second reference voltage level; and
a tenth transistor, having a gate coupled to the gate of the ninth transistor, wherein a first drain/source thereof outputs the second compensation current to the emitter of the second transistor and a second drain/source thereof is coupled to the second reference voltage level.

16. The transistor circuit capable of eliminating influence of component parameter according to claim 10, wherein the component parameter comprises current gain of a transistor.

17. A temperature sensing apparatus, comprising:
a current-producing unit, for producing a first current and a second current;
a first transistor, for receiving the first current;
a second transistor, for receiving the second current;
a current-duplicating unit, for duplicating a base current of the first transistor according to a first proportion and applying to an emitter of the first transistor and for duplicating a base current of the second transistor according to a second proportion and applying to an emitter of the second transistor; and
a measurement unit, for measuring the voltage difference of the base and the emitter of the first transistor and taking the measured voltage difference of the first transistor as a first voltage, for measuring the voltage difference of the base and the emitter of the second transistor and taking the measured voltage difference of the second transistor as a second voltage, and for calculating an ambient temperature by using the first voltage and the second voltage.

18. The temperature sensing apparatus according to claim 17, wherein the current-duplicating unit comprises:
a first current mirror, having a primary side and a slave side, wherein the primary side receives the base current of the first transistor and the slave side produces a first mirror current;
a second current mirror, having a primary side and a slave side, wherein the primary side receives the first mirror current and the slave side outputs a first compensation current to the emitter of the first transistor;
a third current mirror, having a primary side and a slave side, wherein the primary side receives the base current of the second transistor and the slave side produces a second mirror current; and
a fourth current mirror, having a primary side and a slave side, wherein the primary side receives the second mirror current and the slave side outputs a second compensation current to the emitter of the second transistor.

19. The temperature sensing apparatus according to claim 15, wherein the first current mirror comprises:
a third transistor, having a first drain/source and a gate coupled to each other and coupled to the base of the first transistor, and a second drain/source thereof coupled to a first reference voltage level; and
a fourth transistor, having a gate coupled to the gate of the third transistor, wherein a first drain/source thereof outputs the first mirror current and a second drain/source thereof is coupled to the first reference voltage level.

20. The temperature sensing apparatus according to claim 19, wherein the second current mirror comprises:
a fifth transistor, having a first drain/source and a gate coupled to each other and coupled to the first drain/source of the fourth transistor, and a second drain/source thereof coupled to a second reference voltage level; and
a sixth transistor, having a gate coupled to the gate of the fifth transistor, wherein a first drain/source thereof outputs the first compensation current to the emitter of the first transistor and a second drain/source thereof is coupled to the second reference voltage level.

21. The temperature sensing apparatus according to claim 20, wherein the third current mirror comprises:
a seventh transistor, having a first drain/source and a gate coupled to each other and coupled to the base of the second transistor, and a second drain/source thereof coupled to the first reference voltage level; and
an eighth transistor, having a gate coupled to the gate of the seventh transistor, wherein a first drain/source thereof outputs the second mirror current and a second drain/source thereof is coupled to the first reference voltage level.

22. The temperature sensing apparatus according to claim 21, wherein the fourth current mirror comprises:
a ninth transistor, having a first drain/source and a gate coupled to each other and coupled to the first drain/source of the eighth transistor, and a second drain/source thereof coupled to the second reference voltage level; and
a tenth transistor, having a gate coupled to the gate of the ninth transistor, wherein a first drain/source thereof outputs the second compensation current to the emitter of the second transistor and a second drain/source thereof is coupled to the second reference voltage level.
